(19) United States
(12) Patent Application Publication
(10) Pub. No.: US 2020/0120874 A1
(43) Pub. Date: Apr. 23, 2020

(54) APPARATUS AND METHOD FOR A BALE CLEANING TRAILER

(71) Applicant: Jason Jensen, Lava Hot Springs, ID (US)

(72) Inventor: Jason Jensen, Lava Hot Springs, ID (US)

(21) Appl. No.: 16/168,803

(22) Filed: Oct. 23, 2018

(51) Int. Cl. A01D 90/12; A01D 90/10

(52) U.S. Cl. CPC A01D 90/12; A01D 90/10

(57) ABSTRACT

A bale cleaning truck is presented. A flatbed trailer has a conveyor belt for moving one or more bales off the trailer. There are one or more brushes for cleaning a hay bale as it travels down the trailer where at least two vertical brushes that are mounted vertically on the sides of the trailer. A roof brush is attached to the top of the trailer and the final brush is mounted above the trailer to clean the top of the bale. Pumps for operating the brushes and the conveyor belt are hydraulic.

### FIELD OF THE INVENTION

The present invention relates generally to harvesting bales of hay, and particularly to a trailer that is equipped to clean the bales of hay.

### BACKGROUND

In the 1940s most farmers would bale hay in the field with a small tractor with 20 or less horsepower, and the tied bales would be dropped onto the ground as the baler moved through the field. Another team of workers with horses and a flatbed wagon would come by and use a sharp metal hook to grab the bale and throw it up onto the wagon while an assistant stacks the bale, for transport to the barn.

A later time-saving innovation was to tow the flatbed wagon directly behind the baler, and the bale would be pushed up a ramp to a waiting attendant on the wagon. The attendant hooks the bale off the ramp and stacks it on the wagon, while waiting for the next bale to be produced.

Eventually, as tractor horsepower increased, the thrower-baler became possible, which eliminated the need for someone to stand on the wagon and pick up the finished bales. The first thrower mechanism used two fast-moving friction belts to grab finished bales and throw them at an angle up in the air onto the bale wagon. The bale wagon was modified from a flatbed into a three-sided skeleton frame open at the front, to act as a catcher's net for the thrown bales.

As tractor horsepower further increased, the next innovation of the thrower-baler was the hydraulic tossing baler. This employs a flat pan behind the bale knotter. As bales advance out the back of the baler, they are pushed onto the pan one at a time. When the bale has moved fully onto the pan, the pan suddenly pops up, pushed by a large hydraulic cylinder, and tosses the bale up into the wagon like a catapult.

Bales of hay are not perfectly rectangular, round or any other shape. The bales of hay often have strands of hay that protrude through the plane of the bale of hay. This can cause stacks of hay to become uneven and may eventually fall. The stands of hay may also be hard and when a person grabs the bale of hay, he/she may cut their hand from the stands of hay. The process to pack and unpack a bale trailer is long and labor intensive. A new way is needed to reduce cost and improve safety.

### BRIEF DESCRIPTION OF THE DRAWINGS

FIG. 1 is a prior art view of a bale trailer is shown.

FIG. 2 is an exemplary view of bale trailer with a conveyor belt and brushes.

FIG. 3 is an exemplary view of bale trailer with two conveyor belts and brushes.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

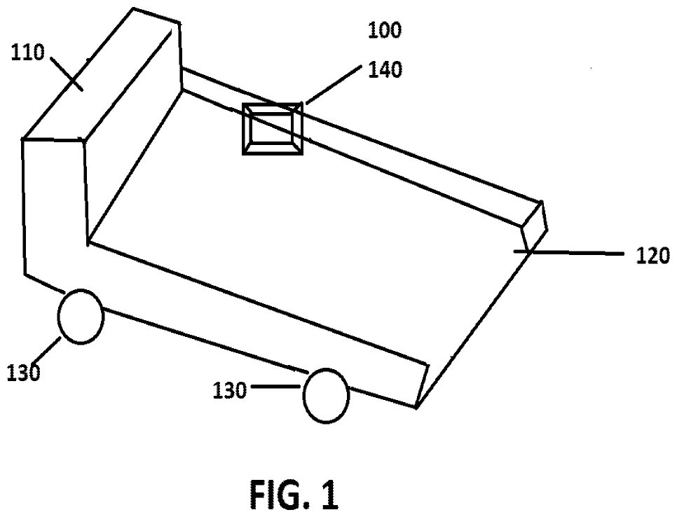

Referring now to FIG. 1, a prior art view of a bale trailer is presented. The bale trailer 100 has a upper portion 110 and a bottom portion 120. The upper portion 110 is elevated. The upper portion 110 of the trailer 100 does not need to be elevated but is normally found elevated. The bottom portion 120 of the bale trailer 100 is also known as a flatbed.

The bottom portion 120 of the bale trailer 100 is significantly longer than wide. The bottom portion 120 of the bale trailer 100 holds the freight that is being delivered. In the case of the bale trailer 100, the bottom portion 110 would contain bales of hay. The bale trailer 100 has at least two wheels 130. The at least two wheels 130 allow the bale trailer 100 to be mobile.

The bottom portion 120 of the bale trailer 100 is typically empty when going to the field to get bales of hay. The bottom portion 120 of the bale trailer 100 is loaded with at least one bale of hay 140. The bale of hay 140 is normally rectangular and is three feet by four feet. The bale of hay 140 may be any shape that is common for a hay baler (not shown) to produce. The size of the bale of hay 140 may vary depending on the hay baler.

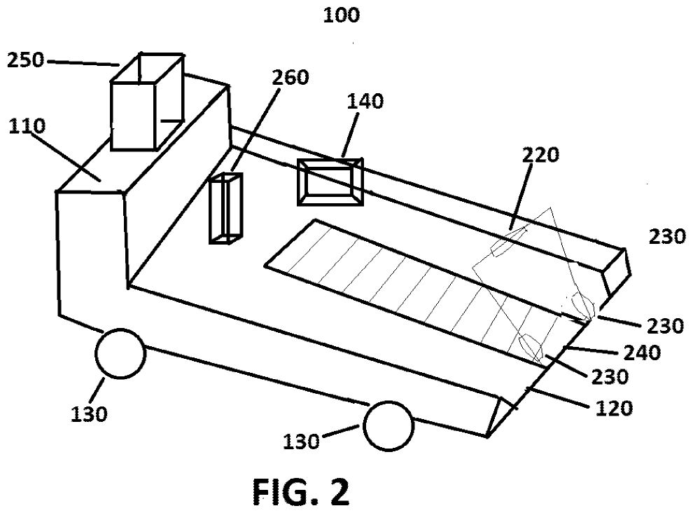

Moving now to FIG. 2 shows an exemplary view of a bale trailer 100 with a conveyor belt 210 and a plurality of brushes 220, 230. The bale trailer 100 has a upper portion 110 and a bottom portion 120. The upper portion 110 is elevated. The upper portion 110 of the trailer 100 does not need to be elevated but is normally found elevated. The bottom portion 120 of the bale trailer 100 is also known as a flatbed. The plurality of brushes 220, 230 are top brush 220 and side brushes 230.

The bottom portion 120 of the bale trailer 100 is significantly longer than wide. The bottom portion 120 of the bale trailer 100 holds the freight that is being delivered. In the case of the bale trailer 100, the bottom portion 110 would contain bales of hay. The bale trailer 100 has at least two wheels 130. The at least two wheels 130 allow the bale trailer 100 to be mobile.

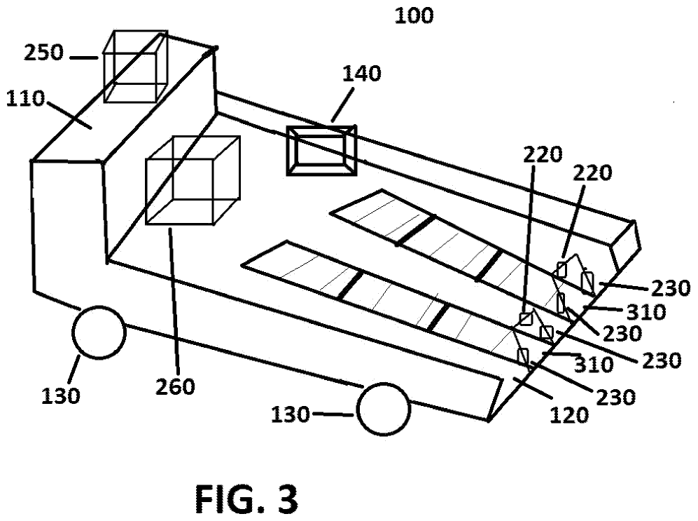

The bottom portion 120 of the bale trailer 100 has a conveyor belt 240. The conveyor belt 240 may be one complete portion, as shown, or more than one portion, see FIG. 3. The conveyor belt 240 may be any length but must be no longer than the length of the bottom 120 of the bale trailer 100. The width of the conveyor belt 240 is generally a little wider than the width of a bale of hay 140.

The upper portion 110 of the bale trailer 100 has a motor 250 for generating power. The motor 250 may be a generator or any other type of motor used to generate power. The motor 250 is coupled to the conveyor belt 240 and may be coupled to the plurality of brushes 220, 230. This allows the conveyor belt 240 to move in a direction to move the bale of hay 150 either onto the bale trailer 100 or off of the bale trailer 100. The plurality of brushes may be a top brush 220 and side brushes 230. The top brush 220 is used to “clean” the top of the bale of hay 140. The side brushes 230 are useful in “cleaning” the sides of the bale of hay 140.

Optionally, the bottom portion 120 of the bale trailer 100 has a hydraulic motor 260. The hydraulic motor 260 may be coupled to the conveyor belt 240 or the plurality of brushes 220, 230. This would allow the conveyor belt 240 to be moved in various directions. Further, if the hydraulic motor 260 is coupled to the plurality of brushes 220, 230, the plurality of brushes 220, 230 could be manipulated to the shape of the bale of hay 140.

Referring now to FIG. 3, a bale trailer for cleaning bales of hay with multiple conveyor belts is presented. The bale trailer 100 has a upper portion 110 and a bottom portion 120. The upper portion 110 is elevated. The upper portion 110 of the trailer 100 does not need to be elevated but is normally found elevated. The bottom portion 120 of the bale trailer 100 is also known as a flatbed.

The bottom portion 120 of the bale trailer 100 is significantly longer than wide. The bottom portion 120 of the bale trailer 100 holds the freight that is being delivered. In the case of the bale trailer 100, the bottom portion 110 would contain bales of hay. The bale trailer 100 has at least two wheels 130. The at least two wheels 130 allow the bale trailer 100 to be mobile.

The bottom portion 120 of the bale trailer 100 has a first conveyor belt 240 and/or a second conveyor belt 310. A second conveyor belt 310 can be useful to speed the process up, thus saving time, man power, etc. The first conveyor belt 240 and/or the second conveyor belt 310 may be one complete portion, as shown, or more than one portion, see FIG. 3. The first conveyor belt 240 and/or the second conveyor belt 310 may be any length but must be no longer than the length of the bottom 120 of the bale trailer 100. The width of the first conveyor belt 240 and/or the second conveyor belt 310 is generally a little wider than the width of a bale of hay 140.

The plurality of brushes may be a top brush 220 and side brushes 230. The top brush 220 is used to “clean” the top of the bale of hay 140. The side brushes 230 are useful in “cleaning” the sides of the bale of hay 140.

The upper portion 110 of the bale trailer 100 has a motor 250 for generating power. The motor 250 may be a generator or any other type of motor used to generate power. The motor 250 is coupled to the conveyor belt 240 and may be coupled to the plurality of brushes 220, 230. This allows the conveyor belt 240 to move in a direction to move the bale of hay 150 either onto the bale trailer 100 or off of the bale trailer 100. The conveyor belts 240, 310 may have multiple portions such as upper portion 320, middle portion 330, and bottom portion 340. Although three portions are shown, one can use any number of portions such that one to any number may be used.

Optionally, the bottom portion 120 of the bale trailer 100 has a hydraulic motor 260. The hydraulic motor 260 may be coupled to the first conveyor belt 240 and/or the second conveyor belt 310 or the plurality of brushes 220, 230. This would allow the first conveyor belt 240 and/or the second conveyor belt 310 to be moved in various directions. Further, if the hydraulic motor 260 is coupled to the plurality of brushes 220, 230, the plurality of brushes 220, 230 could be manipulated to the shape of the bale of hay 140. The

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A bale cleaning truck, the truck comprising:
a flatbed trailer having a first conveyor belt for moving one or more bales off the trailer, two sides, a bottom and a top;
a plurality of brushes for cleaning a hay bale as it travels down the trailer, wherein at least two vertical brushes are mounted vertically on each of the sides of the trailer;
a roof brush that is attached to the top of the trailer, wherein the final brush is mounted above the trailer to clean the top of the bale;
a power source for powering the conveyor belt and the plurality of brushes; and
hydraulic pumps for manipulating the brushes and the conveyor belt.

2. The bale cleaning truck of claim 1, further comprising:
a second conveyor belt for moving a second bale; and
a second plurality of brushes such that the brushes are positioned to clean the bale.

3. The bale cleaning truck of claim 1, wherein each of the one or more brush is hydro adjustable.

4. The bale cleaning truck of claim 1, wherein the bales are brushed on all sides.

5. The bale cleaning truck of claim 1, wherein more than one bale being brushed significantly same time.

6. The bale cleaning truck of claim 1, wherein each side of each of the bales is brushed.

7. The bale cleaning truck of claim 1, wherein the bale is removed from the truck after brushing.

8. The bale cleaning truck of claim 1, wherein the bale is round.

9. The bale cleaning truck of claim 1, wherein the bale is rectangular.

10. A method for brushing bales of hay, comprising:
placing a bale onto a conveyer belt;
actuating the conveyor belt, wherein the conveyor belt moves to the back of the truck;
applying a brush to each side of the bale as the conveyor belt moves the bale; and
collect the lees of the bales that have been removed by the brushes.

11. The method of claim 10 wherein the bale is removed from the truck after brushing.

12. The method of claim 10 wherein the bales are brushed on all sides.

13. The method of claim 10 wherein more than one bale being brushed significantly same time.

14. The method of claim 10 wherein each of the one or more brush is hydro adjustable.
